(19) United States
(12) Patent Application Publication
(10) Pub. No.: US 2017/0026903 A1
(43) Pub. Date: Jan. 26, 2017

(54) SYSTEMS AND METHODS FOR AUTOMATICALLY LINKING TO WIRELESS NETWORKS

(71) Applicant: VONAGE NETWORK, LLC, Holmdel, NJ (US)

(72) Inventors: Natan SHALTIEL, Tel Aviv (IL); Sagi DUDAI, Tel Aviv (IL)

(21) Appl. No.: 14/806,309

(22) Filed: Jul. 22, 2015

(51) Int. Cl. H04W 48/18; G06Q 10/10; H04M 15/00; H04W 8/00; H04W 4/04

(52) U.S. Cl. CPC H04W 48/18; H04W 8/005; H04W 4/04; H04M 15/00; G06Q 10/1093

(57) ABSTRACT

Systems and methods for identifying one of multiple available wireless networks as a preferred wireless network, and for automatically linking to the preferred wireless network, utilize historical linking information to help identify the preferred wireless network. The information used to identify the preferred wireless network could include location information as well as information about the present time.

### BACKGROUND OF THE INVENTION

The invention is related to ways in which a computing device can be instructed to link to wireless networks. In particular, the invention is directed to systems and methods for causing a computing device to automatically link to one of multiple available wireless networks based on past activity and/or the location of the computing device.

Computing devices such as desktop computers, laptop computers, smartphones and other similar devices are typically able to link to a wireless data network via a wireless router. In some instances, a computing device can be within range of multiple wireless routers, each of which provide access to a different wireless data network. Most computing devices with wireless data communication capabilities include a user interface that allows the user to select which of the available wireless networks to which the computing device should link. In many instances, the user interface allows the user to determine a preferred order for the available wireless networks. The computing device then links to the highest ranked wireless network that is currently available. In addition, such a user interface can allow the user to specify that the computing device should automatically link to a particular wireless network, or that the computing device should request permission before linking to the wireless network.

While existing user interfaces for controlling how computing devices to link to wireless networks provide some degree of control over how and whether a computing device links to available wireless networks, such control is limited. In addition, if a user wishes for his computing device to switch from a first wireless network to a second wireless network, it usually requires an affirmative action on the part of the user to accomplish that switch. It would be desirable for a computing device to automatically switch between available wireless networks in a more intelligent and more automated fashion.

### BRIEF DESCRIPTION OF THE DRAWINGS

FIG. 1 is a diagram illustrating how a computing device is able to link to available wireless networks via corresponding wireless access points;

FIG. 2 is another diagram illustrating how a computing device is able to connect to available wireless networks via corresponding wireless access points;

FIG. 3 is a diagram illustrating elements of a computing device embodying the invention;

FIG. 4 is a flow diagram illustrating steps of a first method for identifying a preferred wireless network from among a plurality of available wireless networks;

FIG. 5 is another flow diagram illustrating a second method for identifying a preferred wireless network from among a plurality of available wireless networks;

FIG. 6 is another flow diagram illustrating a third method for identifying a preferred wireless network from among a plurality of available wireless networks; and

FIG. 7 is a flow diagram illustrating a method for identifying a preferred wireless network, and then causing a computing device to link to that preferred wireless network.

### DETAILED DESCRIPTION OF PREFERRED EMBODIMENTS

Systems and methods embodying the invention allow a computing device to automatically connect to one of multiple available wireless networks. Systems and methods embodying the invention may also allow a computing device to automatically switch from a first wireless network to a second wireless network without user intervention. The selection of one of the available wireless networks is made utilizing historical linking information which indicates how a user has chosen to link to the available wireless networks in the past.

While many of the examples discussed below involve actions taken by a mobile computing device, the systems and methods disclosed and claimed herein are equally applicable to stationary computing devices which are able to connect to a wireless data network via a wireless access point. Thus, the claimed systems and methods are not limited to mobile computing devices.

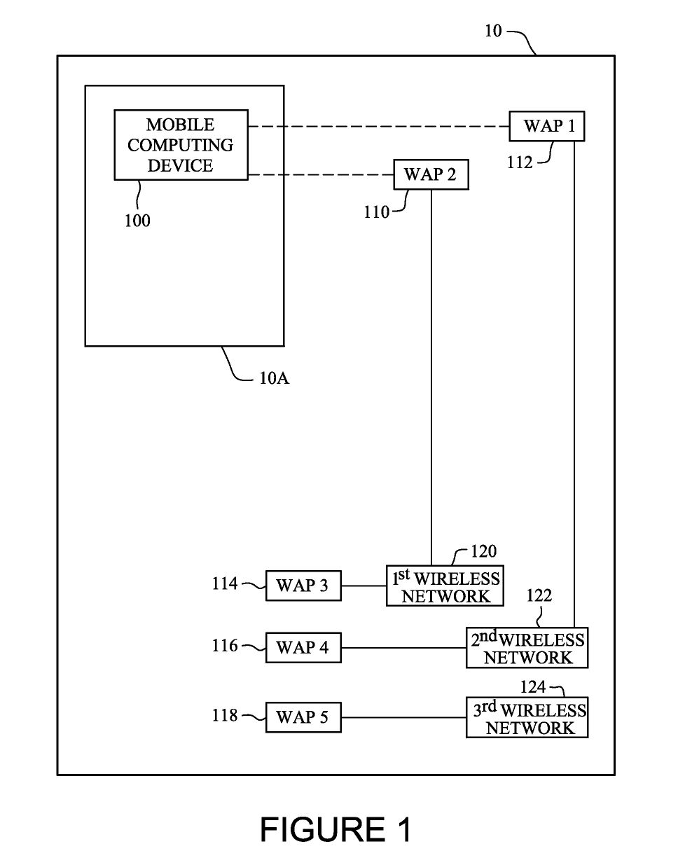

FIG. 1 illustrates how a mobile computing device 100 situated at a first location 10A within a building 10 is within communication range of both a first wireless access point 110 and a second wireless access point 112. The wireless access points can be WiFi routers, or other similar devices that provide the mobile computing device 100 with access to a data network. In this instance, the mobile computing device 100 can connect to either a first wireless network 120 via the first wireless access point 110 or a second wireless network 122 via the second wireless access point 112.

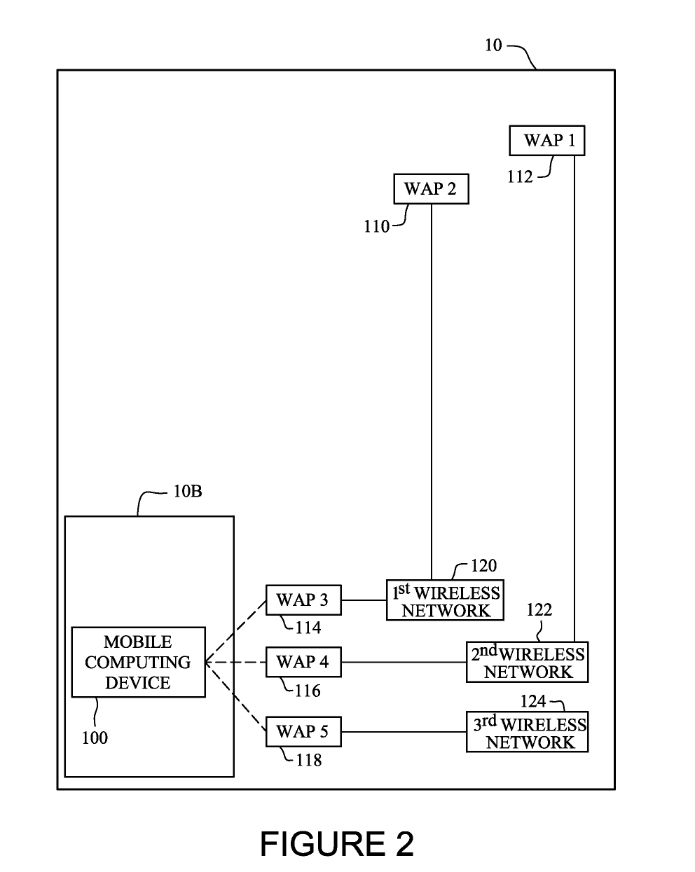

FIG. 2 illustrates the mobile computing device 100 after it has moved to a second location 10B. When in the second location illustrated in FIG. 2, the mobile computing device 100 is able to communicate with a third wireless access point 114, a fourth wireless access point 116, and a fifth wireless access point 118. As a result, when the mobile computing device is in the second location, the mobile computing device 100 can link to either the first wireless network 120, the second wireless network 122, or a third wireless network 124.

For purposes of explaining some of the benefits of the claimed systems and methods, an example will be explained with references to FIGS. 1 and 2. For purposes of this example, we will assume that the mobile computing device 100 is present within a business building 10. The first wireless network 120 is a secured wireless network provided by the business. All actions which are taken by the user while connected to the first wireless network 120 are monitored by the business. However, the business also provides a second unsecured wireless network 122. The business does not monitor actions taken by the user while connected to the second wireless network 122.

When the mobile computing device is present in the first location, as illustrated in FIG. 1, the mobile computing device 100 is located at a lunch room provided by the business. If the mobile computing device 100 is a laptop computer or a smartphone, the user may wish to conduct personal email or access a social networking site while the user is in the business' lunch room. As a result, when the mobile computing device 100 is at the first location in the lunch room, the user typically causes the mobile computing device 100 to connect to the second unsecured wireless network 122 via the second wireless access point 112. This allows the user to conduct personal business without being monitored by the business.

When lunch is over, and the user moves back to his regular workstation, the mobile computing device ends up at the second location illustrated in FIG. 2. At this point, the user needs to access the secured first wireless network 120 in order to resume normal working operations. As a result, the user causes the mobile computing device 100 to connect to the first wireless network 120 via the third wireless access point 114. This allows the user to access confidential business information which is available only via the secured first wireless network 120.

The pattern of activity discussed above will typically occur on a daily basis as the user travels to the lunch room for a lunch break, and at the user moves from the business' lunch room back to his regular workstation. Because of the way most computing devices are caused to link to wireless networks, it is necessary for the user to take active steps in order to cause his mobile computing device 100 to link to the second wireless network 122 upon arrival at the lunch room, and to cause the mobile computing device to switch from the second wireless network 122 to the first wireless network 120 upon return to his workstation. With systems and methods embodying the invention, however, it is possible for the mobile computing device 100 to automatically link to the appropriate wireless network.

As will be explained in more detail below, in systems and methods embodying the invention, a user's past history of how he causes a computing device to connect to various wireless networks is recorded. This information is then used to determine when it would be appropriate to cause the computing device to link to one of multiple available wireless networks, or when it would be appropriate for the computing device to switch from a first wireless network to a second wireless network. The recorded historical linking information can include information about the location of the computing device when it was instructed to link to a particular wireless network. When the historical linking information includes location information, the present location of the computing device may also be taken into account in determining if it is appropriate to link to a particular wireless network, or if it is appropriate to cause the computing device to switch from a first wireless network to a second wireless network.

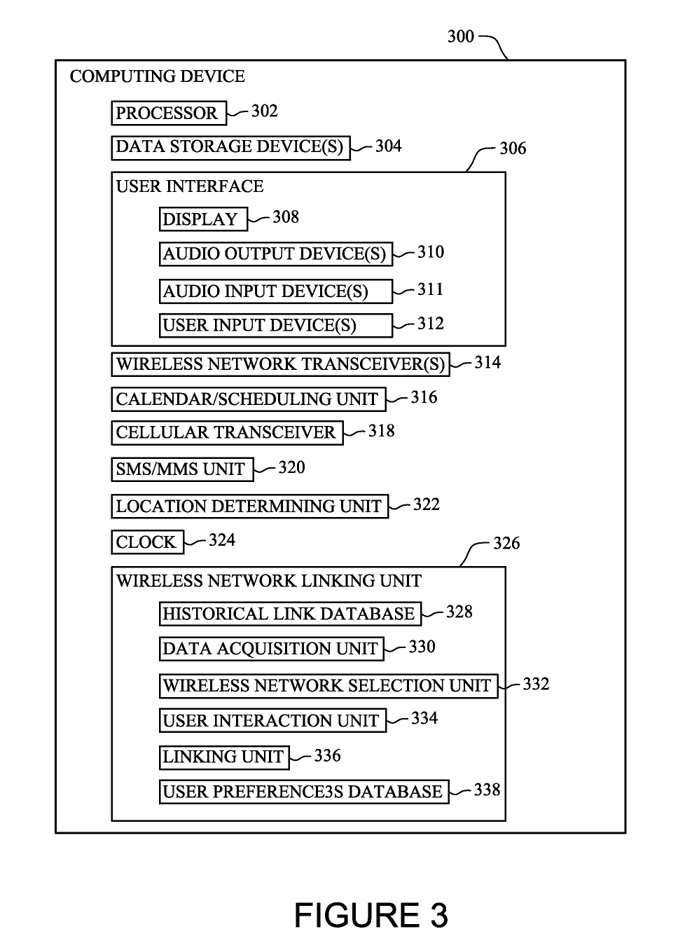

FIG. 3 illustrates elements of a computing device 300 embodying the invention. The computing device 300 includes a processor 302 and one or more data storage devices 304. Software stored on the data storage devices 304 is run by the processor 302 to accomplish various functions, as explained in detail below.

The computing device 300 also includes a user interface 306. The user interface 306 can include a display 308, one or more audio output devices 310, one or more audio input devices 311, and one or more user input devices 312. Examples of user input devices 312 include keys on a keypad, the ability to provide input by interacting with a touch sensitive display screen, as well as various pointing devices such as a mouse or joystick. In some embodiments, a user could provide input via speech. In that case, the user's speech is captured by an audio input device 311, and appropriate speech recognition software is used to interpret the user's spoken input.

The computing device 300 also includes one or more wireless network transceivers 314. When multiple wireless network transceivers 314 are provided, they could each be used to wirelessly connect to different types of wireless access point devices via different communication protocols. Alternatively, two or more of the wireless network transceivers 314 could be configured to connect to the same type of wireless access point devices using the same communication protocol.

The computing device 300 also includes a calendar and/or scheduling unit 316. The calendar/scheduling unit 316 could be embodied by software run by the processor 302 to provide the user with information regarding scheduled appointments. In many instances, the calendar/scheduling unit 316 may be capable of communicating with other computing devices so that a single unified user calendar could be presented to the user via each of the multiple computing devices. For example, a user may keep a single consolidated calendar which is available to the user on a stationary desktop computer, and which is also available to the user via one or more mobile computing devices, such as a separate laptop computer or a smartphone.

In some embodiments, the computing device 300 includes a cellular transceiver 318. The cellular transceiver 318 allows the computing device 300 to place outgoing telephone calls and to receive incoming telephone calls via a cellular telephony system. In addition, an SMS/MMS unit 320 allows the user to send and receive text messages, audio messages or video messages. The SMS/MMS unit 320 may make use of the cellular transceiver 318 to send and receive such messages. The SMS/MMS unit 320 may also be capable of sending and receiving messages via a wireless data network.

The computing device 300 further includes a location determining unit 322. In some instances, the location determining unit 322 could use global positioning system (GPS) technology to determine the location of the computing device 100. In alternate embodiments, location determining unit 322 could utilize the cellular transceiver 318 to determine the location of the mobile computing device 300 by triangulation between available cellular base stations. In other embodiments, the location determining unit 322 could use other forms of technology to determine the location of the computing device 300. For example, information about the present location of the computing device could also be determined by noting which wireless access points are available to the mobile computing device at any given point in time.

The computing device 300 further includes a clock 324. The clock provides at least the current time of day. However, the clock 324 may also be capable of providing information about the date, to include the day, month and year.

The computing device 300 also includes a wireless network linking unit 326. As will be explained in detail below, the wireless network linking unit 326 allows the computing device 100 to connect to and switch between wireless networks on an automated basis. To accomplish its function, the wireless network linking unit 326 includes a historical link database 328 which includes information about when the mobile computing device formed a link with various wireless networks in the past. The location of the computing device 300 when those linking activities occurred may also be recorded in the historical link database 328.

The wireless network linking unit 326 also includes a data acquisition unit 330. The data acquisition unit 330 may obtain various forms of information that is used to help determine if it is appropriate to link to a particular wireless network, or if it is appropriate to switch from a first wireless network to a second wireless network. The data acquisition unit 330 may obtain information from the calendar/scheduling unit 316 that is indicative of the user's schedule. The data acquisition unit 330 may also obtain information from the location determining unit 322 in order to determine the present location of the mobile computing device. The data acquisition unit 330 may also interact with an email system or an SMS/MMS delivery system to obtain information about recently sent or received email or SMS/MMS messages.

The data acquisition unit 330 may also obtain information about telephony activity conducted by the computing device 300, or perhaps telephony activity conducted by the user of the computing device 300 via a separate telephony device. This telephony activity information could be obtained from a call log present on the computing device, or it could be obtained from a telephony system that is responsible for connecting calls for one of the user's telephony devices.

The wireless network linking unit 326 also includes a wireless network selection unit 332 which utilizes information from the historical link database 328, and possibly information acquired from various sources by the data acquisition unit 330, in order to determine whether and when to form a link to an available wireless network. In some instances, this can include identifying one of multiple wireless networks as a preferred wireless network. The preferred wireless network is one that the wireless network selection unit 332 determines the user is most likely to want the computing device 300 to link with at the present time. The way in which the wireless network selection unit 332 accomplishes its functions is discussed in detail below.

The wireless network linking unit 326 also includes a user interaction unit 334. The user interaction unit 334 could be utilized to obtain information from the user about his or her preferences for linking to available wireless networks. In addition, if the wireless network selection unit 332 determines that it would be desirable to switch from a first wireless network to a second wireless network, the user may be presented with a query via the user interaction unit 334, the query asking for confirmation that the switch should occur.

The wireless network linking unit 326 further includes a linking unit 336, which is responsible for forming one or more links to available wireless access points, in order to link the mobile computing device to a desired wireless network. The linking unit 336 may make use of the wireless network transceivers 314 in order to accomplish this function.

In some embodiments, the wireless network linking unit 326 may also include a user preferences database 338. The information in the user preferences database 338 provides an indication of how the user would like the wireless network linking unit 326 to act in various different circumstances.

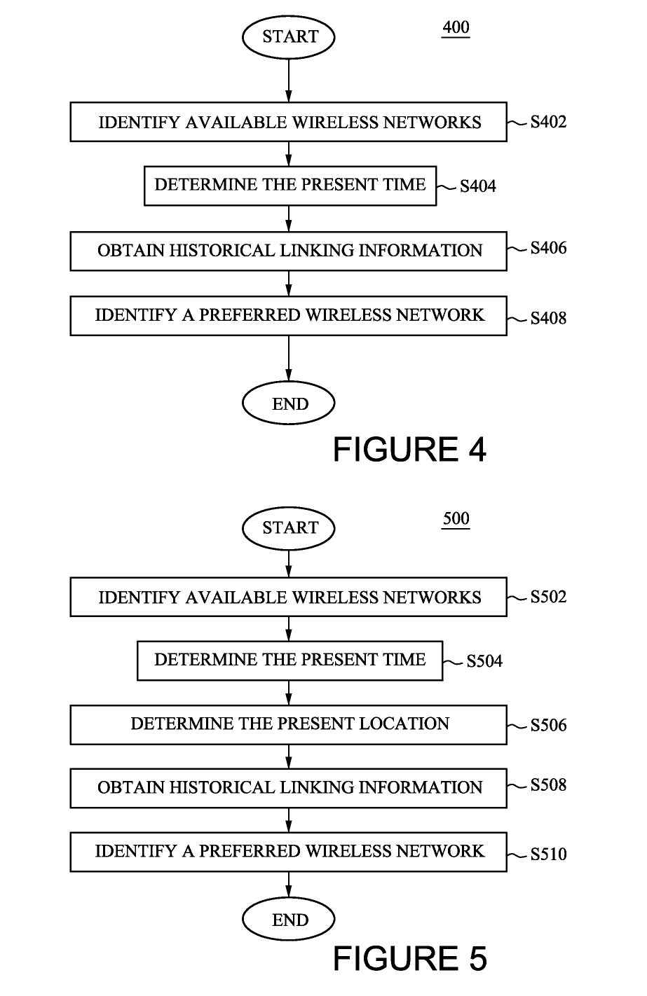

In some methods embodying the invention, a wireless network linking unit 326 of a computing device uses various forms of information to identify which of multiple available wireless networks a user is most likely to wish his computing device to link to. That wireless network is referred to as the preferred wireless network. The methods may further include causing the user's computing device to link to the identified preferred wireless network. As part of the process of causing the computing device to link to the preferred wireless network, the wireless network linking unit 326 may ask the user for permission to link to the preferred wireless network. The information that is used to identify a preferred wireless network could come from a variety of different sources, and that information could be used in a variety of different ways to ultimately identify one of multiple available wireless networks as the preferred wireless network. Some examples of methods embodying the invention will now be explained with reference to FIGS. 4-7.

A first method for identifying a preferred wireless network will now be described in conjunction with the flow diagram presented in FIG. 4. The method 400 starts and proceeds to step S402 where a computing device identifies all available wireless networks to which it can form a link. For example, and with reference to FIG. 1, if the computing device is in the first location illustrated in FIG. 1, the wireless network transceiver(s) 314 of a computing device 100 would determine that the computing device is able to connect to both the first wireless network 120 via the first wireless access point 110, as well as the second wireless network 122 via the second wireless access point 112. Alternatively, if the computing device is located in the second location, as illustrated in FIG. 2, the wireless network transceiver(s) 314 would determine that computing device is capable of connecting to either the first wireless network 120 via the third wireless access point 114, the second wireless network 122 via the fourth wireless access point 116, or the third wireless network 124 via the fifth wireless access point 118.

The method proceeds to step S404 where the current time is determined. This could involve a data acquisition unit 330 of the wireless network linking unit 326 obtaining information from a clock 324 of the computing device. The determination of a present time could include determining the present time of day, as well as determining the date. The date information might also be used to determine the week within a month.

The method then proceeds to step S406 where the wireless network selection unit 332 of a wireless network linking unit 326 obtains historical linking information from a historical link database 328. Information in the historical link database 328 provides an indication of when the mobile computing device linked to individual wireless networks in the past. As a result, information in the historical link database 328 can be used to determine how and when the user typically causes a computing device to connect to various wireless networks. The information in the historical link database 328 could also include information that indicates the location of the computing device when it linked to various wireless networks. The information can also provide an indication of when the user typically requests that the computing device switch from a first wireless network to a second wireless network.

The method then proceeds to step S408 where the wireless network selection unit 332 utilizes the information obtained from the historical linking database 328 and the determined present time to identify one of the available wireless networks as the preferred wireless network. One example of how that determination could be made will be explained with references to FIGS. 1 and 2.

As explained above, FIG. 1 illustrates a mobile computing device located in a lunch room of a business. As also explained above, when the user arrives in the lunch room with the mobile computing device 100, the user typically causes the mobile computing device to connect to the second wireless network via the second wireless access point 112, so that the user can conduct activity that is not monitored by the business. Once the user's lunch break is over, the user moves the mobile computing device 100 to the second location, his regular workstation, as illustrated in FIG. 2. As explained above, the user typically causes the mobile computing device 100 to switch from the second wireless network 122 to the first wireless network 120 after the user has moved back to his regular workstation at the conclusion of his lunch break.

If the mobile computing device 100 is a computing device embodying the invention, as illustrated in FIG. 3, the mobile computing device 100 includes a wireless network linking unit 326 with a historical link database 328. Each time that the user causes the mobile computing device 100 to link to an available wireless network, the linking activity is recorded in the historical link database. In addition to recording an occurrence of a link to a wireless network, the location of the mobile computing device at the time of the linking activity may also be recorded in the historical link database 328.

If the user typically goes to lunch between 12 pm and 1 pm each day, one would expect the information in the historical link database 328 to show that the mobile computing device 100 links to the second wireless network via the second wireless access point 112 at approximately 12 pm each day, and that the mobile computing device is in the lunch room when the link occurs. The information in the historical link database 328 would also indicate that the mobile computing device also typically links to the first wireless network 120 via the third wireless access point 114 at approximately 1 pm each day, and that the mobile computing device is located at the user's regular workstation, when the link to the first wireless network 120 occurs.

If the method illustrated in FIG. 4, was performed at approximately 12 pm by the mobile computing device 100 while it is in the lunch room, as illustrated in FIG. 1, during step S402 a wireless network selection unit 332 of the mobile computing device 100 would find that that it is possible to link to the first wireless network 120 via the first wireless access point 110 or the second wireless network 122 via the second wireless access point 112. During step S404, the current time would be determined to be 12 pm. The historical linking information obtained in step S406 would indicate that at approximately this time, each day, the user instructs the mobile computing device to link to the second wireless network 122 via the second wireless access point 112. During step S408, the wireless network selection unit would use this acquired information to determine that the second wireless network 122 is the preferred wireless network, because this is typically the wireless network that the user wishes to link to at this time of day.

If the method illustrated in FIG. 4, was performed at approximately 1 pm by the mobile computing device 100 while it was located at the user's regular workstation, as illustrated in FIG. 2, during step S402 a wireless network selection unit 332 of the mobile computing device 100 would find that that it is possible to link to the first wireless network 120 via the third wireless access point 114, the second wireless network 122 via the fourth wireless access point 116, or the third wireless network via the fifth wireless access point 118. During step S404, the current time would be determined to be 1 pm. The historical linking information obtained in step S406 would indicate that at approximately this time, each day, the user instructs the mobile computing device to link to the first wireless network 122 via the third wireless access point 114. During step S408, the wireless network selection unit 332 would use this acquired information to determine that the first wireless network 120 is the preferred wireless network, because this is typically the wireless network that the user wishes to link to at this time of day.

Steps of a second method for identifying one of multiple available wireless networks as a preferred wireless network is illustrated in FIG. 5. The method 500 begins and proceeds to S502 where a computing device identifies any available wireless networks to which it can form a link. The method then proceeds to step S504 where the present time is determined. The method then proceeds to step S506 where the present location of the mobile computing device is determined. This could be accomplished by obtaining information from a location determining unit 322 of the computing device. Next, in step S508, historical linking information is obtaining from one or more historical link databases 328.

In step S510, the wireless network selection unit 332 of the computing device utilizes the acquired information to identify a preferred wireless network to which the mobile computing device should form a link. The acquisition of the present location information could be utilized in connection with location information recorded in the historical link database 328 to help identify one of the available wireless networks as the preferred wireless network.

For example if the computing device performing the method illustrated in FIG. 5 is the mobile computing device 100 illustrated in FIGS. 1 and 2, information in the historical link database 328 would indicate that the user typically instructs the mobile computing device to link to the second wireless network 122 via the second wireless access point 112 at approximately 12 pm each day when the mobile computing device is located in the lunch room. Information in the historical link database 328 also would indicate that the user typically instructs the mobile computing device 100 to link to the first wireless network 120 via the third wireless access point 114 at approximately 1 pm each day when the mobile computing device is located at the user's regular workstation.

If the method illustrated in FIG. 5 is performed by the mobile computing device at 12:01 pm, and the mobile computing device is determined to be located at the user's regular workstation, the location information could be used to determine that the mobile computing device has not yet arrived at the lunch room, and for this reason, the second wireless network may not be identified as the preferred wireless network in step S510. Instead, the first wireless network 120 may be identified as the preferred wireless network.

If the method illustrated in FIG. 5 is again performed at 12:05, and the location of the mobile computing device 100 is then determined to be the lunch room, the second wireless network 122 could be identified as the preferred wireless network in step S510. Thus, the location information can be helpful in correctly identifying the preferred wireless network.

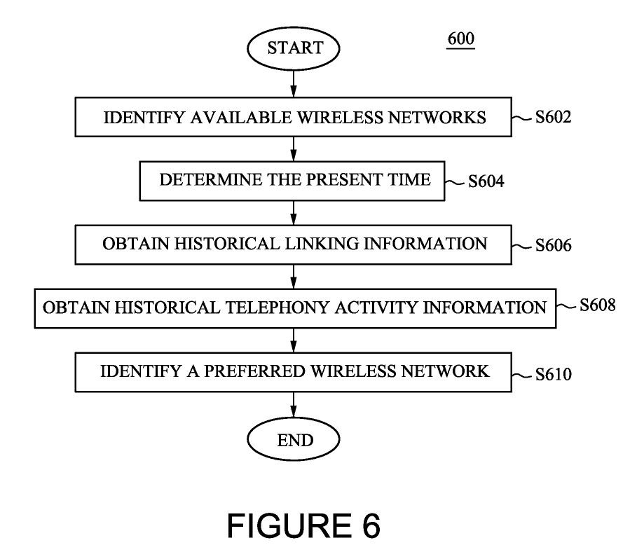

In the methods described above, information about available wireless networks, information about the present time, and historical linking information, which can include location information, was utilized to help identify one of multiple available wireless networks as a preferred wireless network. In an alternate method embodying the invention, as illustrated in FIG. 6, historical telephony activity is also taken into account in identifying a preferred wireless network.

As shown in FIG. 6, the method 600 begins and proceeds to step S602 where the computing device identifies available wireless networks. Next, in step S604, the present time is determined. In step S606, historical linking information is obtained.

Next, in step S608, historical telephony activity is obtained. As noted above, the mobile computing device could be a smartphone which is used to place and receive telephone calls. The historical telephony activity could include information about calls that the user made or calls that the user received via the smartphone. In instances where the computing device is not a smartphone, the historical telephony activity could be for a separate telephony device that the user typically uses to place and receive telephone calls. This could include a cellular telephone, or a work telephone. This historical telephony activity information is then used to help identify a preferred wireless network to which the computing device should form a link.

For example, information obtained from the historical linking database, and the historical telephony activity information, may indicate that each time the user receives a telephone call from a particular telephone number, the user thereafter causes his computing device to switch from a first wireless network to a second wireless network. If that pattern of activity is detected, then in step S610, the wireless network selection unit 332 of the computing device can use that information to identify a preferred wireless network. For example, if the wireless network selection unit 332 notes that the user has just received a telephone call from that telephone number, and the historical linking information indicates that the user would typically then switch from a first wireless network to a second wireless network upon receiving such a telephone call, the wireless network selection unit 332 could identify the second wireless network as the preferred wireless network.

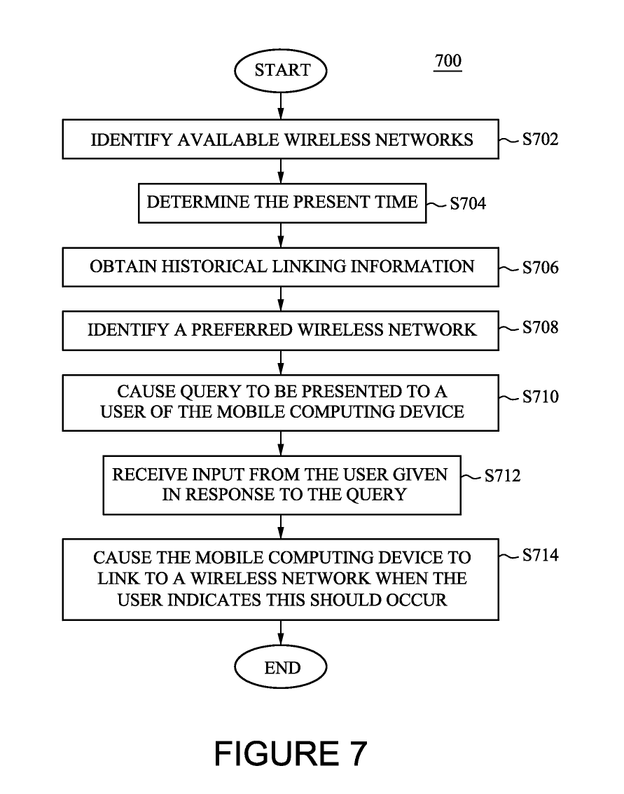

In each of the methods discussed above, once a preferred wireless network has been identified, the computing device may automatically link to the preferred wireless network without user intervention. In alternate methods embodying the invention, the user may be asked for permission to link to a preferred wireless network. FIG. 7 illustrates another method embodying the invention where the user is asked for permission before the computing device links to a preferred wireless network.

The method 700 begins and proceeds to step S702, where the computing device identifies available wireless networks. In step S704, the present time is determined. In step S706, historical linking information is obtaining from a historical link database. In step S708, a preferred wireless network is then determined using the present time and historical linking information. In step S710, a query is then presented to the user of the mobile computing device, asking if the user wishes for the computing device to link to the preferred wireless network. The query could be provided via the user interaction unit 334 of the wireless network linking unit 326 of a computing device. The user interaction unit 334 could utilize the user interface 306 of the computing device to cause the query to be presented to the user.

In step S712, the user interaction unit 334 then receives input from the user which is provided in response to that query. The input would typically be confirmation that the computing device should link to the preferred wireless network, or an instruction to not link to the preferred wireless network. If the user input received in step S712 indicates that the computing device should link to the preferred wireless network, then in step S714 the wireless network selection unit 332 causes the computing device to link to the preferred wireless network.

In the methods described above, various items of information are gathered and then used to identify a preferred wireless network. The identification of a preferred wireless network could be made in various different ways. In some instances, a score is calculated for each of the available wireless networks, the score giving an indication of how likely it is that the user would wish to link to that wireless network. Once scores are calculated for each of the available wireless networks, the wireless network with the highest score is identified as the preferred wireless network.

In alternate embodiments, other methods could be used to identify a preferred wireless network. For example, a decision tree could be used, or an algorithm could be followed utilizing the obtained information.

In addition, user preferences which are recorded in a user preferences database 338 may also be taken into account in identifying a preferred wireless network. Information from the user preferences database 338 could be used to calculate a score for each of the available wireless networks. Alternatively, information in the user preferences database could overrule the calculated scores in certain circumstances.

Methods embodying the invention could be performed at various different times. For example, a method embodying the invention could be performed each time that a computing device starts, or each time that the computing device is wakened from a dormant status. In addition, in some embodiments, methods as described above could be performed on a periodic basis anytime that the computing device is active. In yet other embodiments, methods as described above, may only be performed when a location determining unit 322 of the computing device indicates that the computing device has moved from a first location to a second location.

The information acquired to determine a preferred wireless network may also be calendar or scheduling information. For example, if the user typically meets with a particular individual on a regular basis, and the historical link information indicates that the user typically switches from a first wireless network to a second wireless network in preparation for such a meeting, this information could also be used to identify a preferred wireless network. If the wireless network linking unit 326 knows that the user typically makes a switch from a first wireless network to a second wireless network just prior to that regular meeting, the switch could be made on an automated basis because the information in the calendar/scheduling unit 316 indicates that such a meeting is about to occur.

In yet other embodiments, information about the receipt or transmission of an email message, or a SMS/MMS message, could also be used to identify a preferred wireless network. For example, if the historical link information indicates that each time the user receives an email message from a particular individual, the user switches from a first wireless network to a second wireless network, then receipt of an email message from that individual could be used to help identify the preferred wireless network.

In many of the foregoing descriptions, a wireless network linking unit present on a computing device could be embodied by software and databases resident on the computing device itself. In alternate embodiments, a browser running on the computing device may access a software and/or databases located on some other device via a data network connection. For example, software running on a remote server and/or databases on that remote server could provide some or all of the functionality of the wireless network linking unit.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method performed by a computing device for identifying a wireless network to which the computing device could link, comprising:
identifying wireless networks to which the computing device could link as available wireless networks;
determining the present time;
obtaining information about the circumstances under which the computing device linked to one or more of the available wireless networks in the past; and
identifying one of the available wireless networks as a preferred wireless network based on the determined time and the obtained information.

2. The method of claim 1, wherein determining the present time comprises determining at least one of the time of day, the date, the day of the week, the day of the month, and/or the week of the month.

3. The method of claim 1, wherein obtaining information comprises obtaining information about the time of day that the computing device linked to at least one of the available wireless networks in the past.

4. The method of claim 1, wherein the step of obtaining information further comprises obtaining information about the location of the computing device when the computing device linked to one or more of the available wireless networks in the past, wherein the method further comprises determining a present location of the computing device, and wherein the step of identifying one of the available wireless networks as a preferred wireless network is also based on the determined location and the obtained location information.

5. The method of claim 1, wherein the step of obtaining information further comprises obtaining historical scheduling information about a schedule of a user of the computing device at the approximate time in the past when the computing device linked to one or more of the available wireless networks, wherein the method further comprises obtaining information about the user's schedule at approximately the present time, and wherein the step of identifying one of the available wireless networks as a preferred wireless network is also based on the obtained historical scheduling information, and the obtained information about the user's schedule at approximately the present time.

6. The method of claim 1, wherein the step of obtaining information further comprises obtaining historical telephony activity information for a user of the computing device which occurred at the approximate time in the past when the computing device linked to one or more of the available wireless networks, wherein the method further comprises obtaining recent telephony activity information for the user that is indicative of telephony activity that occurred just prior to the present time, and wherein the step of identifying one of the available wireless network as a preferred wireless network is also based on the obtained historical telephony activity information, and the obtained recent telephony activity information.

7. The method of claim 1, wherein identifying one of the available networks as a preferred wireless network comprises:
calculating a desirability score for each of the available wireless networks; and
identifying the available wireless network with the highest desirability score as a preferred wireless network.

8. The method of claim 1, further comprising:
causing a query to be presented to a user of the computing device, the query asking the user whether the user would like the computing device to link to the preferred wireless network;
receiving input from the user that the user provides in response to the query; and
causing the computing device to link to the preferred wireless network when the received input indicates that the user would like the computing device to link to the preferred wireless network.

9. The method of claim 1, further comprising causing the computing device to link to the preferred wireless network.

10. The method of claim 1, wherein the step of identifying one of the available wireless networks as a preferred wireless network is also based upon a previously recorded user preference relating to at least one wireless network.

11. A system for identifying a wireless network to which a computing device could link, comprising:
means for identifying wireless networks to which the computing device could link as available wireless networks;
means for determining the present time;
means for obtaining information about the circumstances under which the computing device linked to one or more of the available wireless networks in the past; and
means for identifying one of the available wireless networks as a preferred wireless network based on the determined time and the obtained information.

12. A system for identifying a wireless network to which a computing device could link, comprising:
at least one wireless network transceiver that is configured to identify wireless networks to which the computing device could link as available wireless networks;
a data acquisition unit that determines the present time; and
a wireless network selection unit that obtains information about the circumstances under which the computing device linked to one or more of the available wireless networks in the past, and that identifies one of the available wireless networks as a preferred wireless network based on the determined time and the obtained information.

13. The system of claim 12, wherein the data acquisition unit determines the present time as at least one of the time of day, the date, the day of the week, the day of the month, and/or the week of the month.

14. The system of claim 12, wherein the wireless network selection unit obtains information about the time of day that the computing device linked to at least one of the available wireless networks in the past.

15. The system of claim 12, wherein the wireless network selection unit obtains information about the location of the computing device when the computing device linked to one or more of the available wireless networks in the past, wherein the wireless network selection unit determines a present location of the computing device, and wherein the wireless network selection unit identifies one of the available wireless networks as a preferred wireless network based on the determined location and the obtained location information.

16. The system of claim 12, wherein the wireless network selection unit obtains historical scheduling information about a schedule of a user of the computing device at the approximate time in the past when the computing device linked to one or more of the available wireless networks, wherein the wireless network selection unit obtains information about the user's schedule at approximately the present time, and wherein the wireless network selection unit identifies one of the available wireless networks as a preferred wireless network based on the obtained historical scheduling information, and the obtained information about the user's schedule at approximately the present time.

17. The system of claim 12, wherein the wireless network selection unit obtains historical telephony activity information for a user of the computing device which occurred at the approximate time in the past when the computing device linked to one or more of the available wireless networks, wherein the wireless network selection unit obtains recent telephony activity information for the user that is indicative of telephony activity that occurred just prior to the present time, and wherein the wireless network selection unit identifies one of the available wireless network as a preferred wireless network based on the obtained historical telephony activity information, and the obtained recent telephony activity information.

18. The system of claim 12, wherein the wireless network selection unit identifies one of the available networks as a preferred wireless network by:
calculating a desirability score for each of the available wireless networks; and
identifying the available wireless network with the highest desirability score as a preferred wireless network.

19. The system of claim 12, further comprising:
a user interaction unit that causes causing a query to be presented to a user of the computing device, the query asking the user whether the user would like the computing device to link to the preferred wireless network, and that receives input from the user that the user provides in response to the query, and
a linking unit that causes the computing device to link to the preferred wireless network when the received input indicates that the user would like the computing device to link to the preferred wireless network.

20. The system of claim 12, further comprising a linking unit that causes the computing device to link to the preferred wireless network.

21. The system of claim 1, wherein the wireless network selection unit identifies one of the available wireless networks as a preferred wireless network based upon a previously recorded user preference relating to at least one wireless network.
